(19) United States
(12) Patent Application Publication
(10) Pub. No.: US 2013/0110350 A1
(43) Pub. Date: May 2, 2013

(54) SHOCK ABSORBER CONTROL APPARATUS AND SHOCK ABSORBER CONTROL METHOD

(71) Applicants: Sang Hwan CHOI, Hwaseong (KR); In Taek SONG, Suwon (KR); Gwan Ha JEONG, Suwon (KR)

(72) Inventors: Sang Hwan CHOI, Hwaseong (KR); In Taek SONG, Suwon (KR); Gwan Ha JEONG, Suwon (KR)

(73) Assignee: Samsung Electro-Mechanics Co., Ltd., Suwon (KR)

(21) Appl. No.: 13/347,176

(22) Filed: Jan. 10, 2012

(30) Foreign Application Priority Data
Oct. 28, 2011 (KR) 10-2011-0111496

(51) Int. Cl. B60G 17/018

(52) U.S. Cl. 701/37

(57) ABSTRACT

There are provided a shock absorber control apparatus and a shock absorber control method, capable of controlling a shock absorber in advance by including a distance sensing module sensing a distance between a bottom surface of a vehicle and a road surface. The shock absorber control apparatus includes: a vehicle movement information sensing module sensing vehicle movement information; a distance sensing module sensing a distance between a bottom surface of a vehicle and a road surface; and an electronic control unit receiving the vehicle movement information and the distance to generate a signal for controlling the shock absorber and transmit the signal to the shock absorber.

### CROSS-REFERENCE TO RELATED APPLICATIONS

This application claims the priority of Korean Patent Application No. 10-2011-0111496 filed on Oct. 28, 2011, in the Korean Intellectual Property Office, the disclosure of which is incorporated herein by reference.

### BACKGROUND OF THE INVENTION

1. Field of the Invention

The present invention relates to a shock absorber control apparatus and a shock absorber control method, capable of controlling in advance a shock absorber by including a distance sensing module sensing a distance between a bottom surface of a vehicle and a road surface.

2. Description of the Related Art

Generally, wheels have a rotational motion and a vertical motion due to unevenness in a road surface during vehicle movement and repeatedly undergo vertical motions within a very short time of period at the time of movement at high speed. In this case, since the acceleration of a vehicle body in a direction perpendicular to a road surface is several times greater than the acceleration of gravity, significant impacts may be imparted to the vehicle due to the unevenness of a road surface.

As described above, in order to mitigate impacts generated during vehicle movement, a spring is provided between a vehicle body and vehicle wheels and at a bottom of a sheet, such that the spring absorbs impacts transferred from the unevenness of a road surface and vibrations transferred to the wheels during vehicle movement, and a shock absorber is mounted in a predetermined position outside of the spring provided between the vehicle body and the wheels, such that the shock absorber absorbs and rapidly damps vibrations of the spring generated due to impacts applied thereto, thereby improving vehicle ride comfort.

However, the shock absorber has a structure in which an amount of pressure of the shock absorber varies only by a magnitude of an impact generated after the impact has been applied to a vehicle, and therefore, may have insufficient damping action. As a result, vehicle performance may be deteriorated by impacts generated when a vehicle moves on an uneven road surface.

In detail, the shock absorber may be controlled according to the velocity of a vehicle, a gear state, and previous driver setting, and therefore, may not cope with unexpected situations such as unevenness of a road surface, in advance. Even when a driver performs the operation of changing a damping force of the shock absorber in advance by recognizing the unexpected situations, the operation of the shock absorber may be considerably complicated. Further, vehicle ride comfort or vehicle movement safety may be damaged when the pressure of the changed shock absorber after the unexpected situations end does not rapidly return to an original state thereof.

### SUMMARY OF THE INVENTION

An aspect of the present invention provides a shock absorber control apparatus and a shock absorber control method, capable of controlling a shock absorber in advance to improve vehicle ride comfort or vehicle movement safety.

According to an aspect of the present invention, there is provided a shock absorber control apparatus, including: a vehicle movement information sensing module sensing vehicle movement information; a distance sensing module sensing a distance between a bottom surface of a vehicle and a road surface; and an electronic control unit receiving the vehicle movement information and the distance to generate a signal for controlling the shock absorber and transmit the signal to the shock absorber.

The vehicle movement information sensing module may include a velocity sensor sensing a velocity of the vehicle, a steering angle sensor sensing a steering angle of the vehicle, and a gear sensor sensing a gear state of the vehicle.

The distance sensing module may include at least two cameras.

The distance sensing module may include a camera having a linear pixel arrangement.

The distance sensing module may sense the distance between the bottom surface of the vehicle and the road surface along a virtual line positioned on the road surface within a viewing angle range of the distance sensing module.

The electronic control unit may receive the vehicle movement information to thereby calculate an expected vehicle movement path.

The distance sensing module may sense the distance between the bottom surface of the vehicle and the road surface along a virtual line positioned on the road surface within a viewing angle range of the distance sensing module, and the electronic control unit may extract the distance between the bottom surface of the vehicle and the road surface at a point at which the virtual line positioned on the road surface within the viewing angle range of the distance sensing module intersects with the expected vehicle movement path.

The electronic control unit may determine the point as an unexpected point when the distance between the bottom surface of the vehicle and the road surface at the point is higher than a preset maximum value or lower than a preset minimum value, calculate time remaining until arrival at the unexpected point, and transmit the signal to the shock absorber within the time remaining until arrival at the unexpected point.

The electronic control unit may generate a signal allowing a pressure of the shock absorber to be reduced when the distance between the bottom surface of the vehicle and the road surface is lower than a preset minimum value and transmit the generated signal to the shock absorber, and the electronic control unit may generate a signal allowing the pressure of the shock absorber to be increased when the distance between the bottom surface of the vehicle and the road surface is higher than a preset maximum value and transmit the generated signal to the shock absorber.

When the electronic control unit generates a signal allowing a pressure of the shock absorber to be increased or a signal allowing the pressure of the shock absorber to be reduced and transmits the generated signal to the shock absorber, the electronic control unit may redetermine whether the distance between the bottom surface of the vehicle and the road surface is within ranges of preset maximum and minimum values, within a preset time from time when the signal is transmitted to the shock absorber, and if the distance is within the ranges of preset maximum and minimum values, generate a signal allowing the pressure of the shock absorber to be returned to an original state and transmit the generated signal to the shock absorber.

According to another aspect of the present invention, there is provided a shock absorber control method, including: a sensing process of sensing vehicle movement information by a vehicle movement information sensing module and sensing a distance between a bottom surface of a vehicle and a road surface by a distance sensing module; and a controlling process of controlling a shock absorber by generating a signal for controlling the shock absorber from the vehicle movement information and the distance to transmit the generated signal to the shock absorber.

The controlling process may include a path calculation process, a distance extraction process, and a control signal transmission process.

In the sensing process, the distance between the bottom surface of the vehicle and the road surface may be sensed along a virtual line positioned on the road surface within a viewing angle range of the distance sensing module.

In the path calculation process, an expected vehicle movement path may be calculated from the vehicle movement information.

In the sensing process, the distance between the bottom surface of the vehicle and the road surface may be sensed along a virtual line positioned on the road surface within a viewing angle range of the distance sensing module, and in the distance extraction process, the distance between the bottom surface of the vehicle and the road surface at a point at which the virtual line positioned on the road surface within the viewing angle range of the distance sensing module intersects with the expected vehicle movement path may be extracted.

The control signal transmission process may include a first control signal transmission process and the first control signal transmission process may include determining the point as an unexpected point when the distance between the bottom surface of the vehicle and the road surface at the point is higher than a preset maximum value or lower than a preset minimum value, calculating time remaining until arrival at the unexpected point, and transmitting the signal to the shock absorber within the time remaining until arrival at the unexpected point.

The control signal transmission process may include a second control signal transmission process after the first control signal transmission process, and the second control signal transmission process may include generating a signal allowing a pressure of the shock absorber to be reduced when the distance between the bottom surface of the vehicle and the road surface is lower than the preset minimum value to thereby transmit the generated signal to the shock absorber and generating a signal allowing the pressure of the shock absorber to be increased when the distance between the bottom surface of the vehicle and the road surface is higher than the preset maximum value to thereby transmit the generated signal to the shock absorber.

The control signal transmission process may include a third control signal transmission process after the second control signal transmission process, and the third control signal transmission process may include redetermineing whether the distance between the bottom surface of the vehicle and the road surface is within ranges of preset maximum and minimum values, within a preset time from time when the signal is transmitted to the shock absorber, and if the distance is within the ranges of preset maximum and minimum values, generating a signal allowing the pressure of the shock absorber to be returned to an original state to thereby transmit the generated signal to the shock absorber.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a block configuration diagram of a shock absorber control apparatus according to an embodiment of the present invention;

FIG. 2 is a schematic diagram showing a virtual line positioned on a road surface within a viewing angle range of a distance sensing module according to an embodiment of the present invention;

FIG. 3 is a schematic diagram showing a point at which a virtual line positioned on a road surface within a viewing angle range of a distance sensing module according to an embodiment of the present invention intersects with an expected movement path;

FIG. 4 is a graph showing a distance change between a bottom surface of a vehicle and a road surface at the point at which a virtual line positioned on a road surface within a viewing angle range of a distance sensing module according to an embodiment of the present invention intersects with an expected movement path, depending on a change in a vehicle movement distance according to an embodiment of the present invention;

FIG. 5 is a flow chart of a shock absorber control method according to an embodiment of the present invention; and

FIG. 6 is a flow chart of a first control signal transmission process, a second control signal transmission process, and a third control signal transmission process according to an embodiment of the present invention.

### DETAILED DESCRIPTION OF THE PREFERRED EMBODIMENT

Embodiments of the present invention will be described with reference to the accompanying drawings. The embodiments of the present invention may be modified in many different forms and the scope of the invention should not be limited to the embodiments set forth herein. Rather, these embodiments are provided so that this disclosure will be thorough and complete, and will fully convey the concept of the invention to those skilled in the art . In the drawings, the shapes and dimensions may be exaggerated for clarity, and the same reference numerals will be used throughout to designate the same or like components.

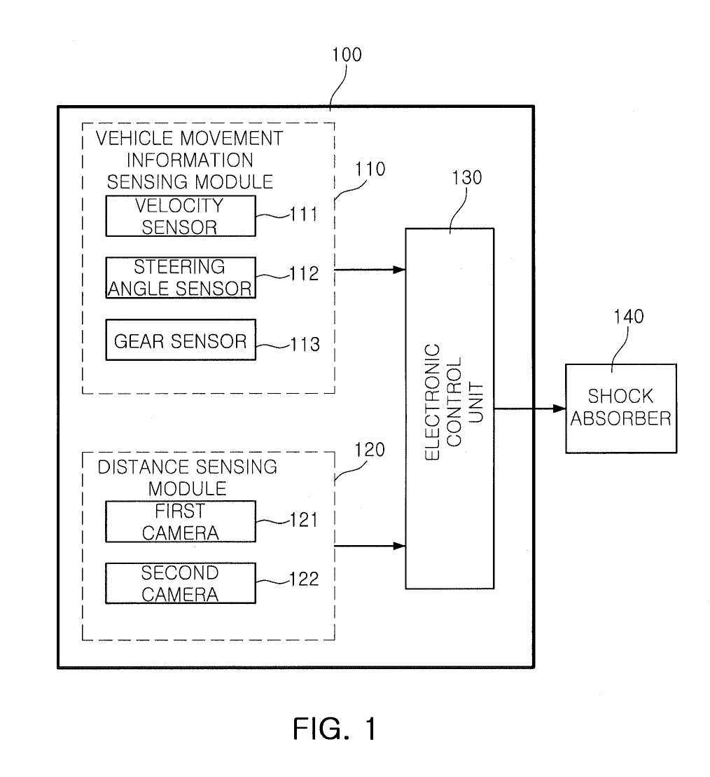

FIG. 1 is a block configuration diagram of a shock absorber control apparatus according to an embodiment of the present invention.

As shown in FIG. 1, a shock absorber control apparatus 100 according to an embodiment of the present invention may include a vehicle movement information sensing module 110, a distance sensing module 120, and an electronic control unit 130.

The vehicle movement information sensing module 110, which is a module sensing vehicle movement information, transmits the vehicle movement information to the electronic control unit 130. The vehicle movement information may include a velocity of a vehicle, a steering angle of the vehicle, and a gear state of the vehicle. The vehicle movement information sensing module 110 according to the embodiment of the present invention may include a velocity sensor 111 sensing a velocity of the vehicle, a steering angle sensor 112, and a gear sensor 113.

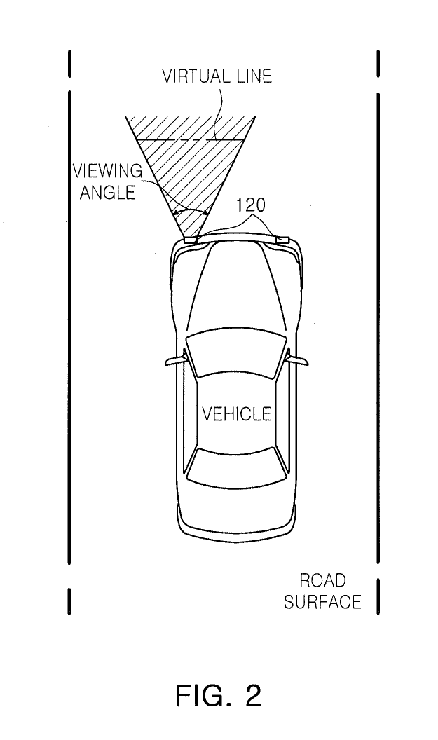

The distance sensing module 120 is a module sensing a distance between a bottom surface of the vehicle and a road surface. As described below, unexpected situations on the road surface from the distance sensed by the distance sensing module 120 may be recognized in advance. The distance sensing module 120 according to the embodiment of the present invention may include a first camera 121 and a second camera 122 as shown in FIG. 1. The distance sensing module 120 may also include more than two cameras. Since the distance sensing module 120 needs to sense in advance the distance between the road surface and the bottom surface of the vehicle before vehicle wheels pass through the road surface and therefore, it needs to be positioned in front of a front wheel of the vehicle in a vehicle movement direction. In addition, the distance sensing module 120 according to the embodiment of the present invention may sense the distance between the bottom surface of the vehicle and the road surface along a virtual line positioned on the road surface within a viewing angle range of the distance sensing module 120. In regard to this, the description thereof will be described with reference to FIG. 2.

The electronic control unit 130 may generate a control signal controlling an shock absorber by receiving the vehicle movement information from the vehicle movement information sensing module 110 and the distance between the bottom surface of the vehicle and the road surface from the distance sensing module 120 and transmit the generated signal to the shock absorber to thereby control the shock absorber.

More specifically, the electronic control unit 130 may receive the vehicle movement information from the vehicle movement information sensing module 110, for example, a velocity of an operating vehicle, a steering angle, and a gear state, to calculate an expected vehicle movement path. The electronic control unit 130 extracts the distance between the bottom surface of the vehicle and the road surface at a point at which the virtual line positioned on the road surface within the viewing angle range of the distance sensing module 120 intersects with the expected vehicle movement path, based on the calculated expected vehicle movement path.

The electronic control unit 130 continues monitoring the distance between the bottom surface of the vehicle and the road surface extracted at the point and then, determines the point as an unexpected point when the distance extracted at the point is higher than a preset maximum value or lower than a preset minimum value. Further, the time consumed for the vehicle to arrive at the unexpected point is calculated based on the velocity of the vehicle. The electronic control unit 130 generates the control signal and transmits the generated control signal to the shock absorber 140 within the time remaining until arrival at the unexpected point, thereby allowing the pressure of the shock absorber 140 to be changed. The case in which the distance between the bottom surface of the vehicle and the road surface is higher than the preset maximum value means that a depression recessed downwardly from the road surface exists at the point. In this case, the electronic control unit 130 generates a control signal allowing the pressure of the shock absorber 140 to be increased and transmits the generated signal to the shock absorber 140. As the pressure of the shock absorber 140 is increased, the distance between the wheels and a vehicle body is extended, such that the vehicle body may be maintained to have the same height from the the road surface on which the vehicle moves even though the wheels pass through depression recessed downwardly from the road surface . On the other hand, the case in which the distance between the bottom surface of the vehicle and the road surface is lower than the preset minimum value means that obstacles protruded upwardly from the road surface exist at the point. In this case, the electronic control unit 130 generates a control signal allowing the pressure of the shock absorber 140 to be reduced and transmits the generated signal to the shock absorber 140. As the pressure of the shock absorber 140 is reduced, the distance between the wheels and the vehicle body is shorten, such that the vehicle body may be maintained to have the same height from the the road surface on which the vehicle moves even though the wheels pass through the obstacles protruded upwardly from the road surface.

In order to maintain the same vehicle ride comfort after and before the unexpected point, the state of the shock absorber 140 after having passed through the unexpected point may be maintained to be the same as that of the shock absorber 140 before the unexpected point. Therefore, when the electronic control unit 130 generates the control signal allowing the pressure of the shock absorber 140 to be increased or the control signal allowing the pressure of the shock absorber 140 to be reduced and transmits the generated signals to the shock absorber 140, the electronic control unit 130 redetermines whether the distance between the bottom surface of the vehicle and the road surface is within the ranges of preset maximum and minimum values, within a preset time from the time when the control signal is transmitted to the shock absorber. When the distance is within the ranges of preset maximum and minimum values, the electronic control unit 130 determines that the vehicle has passed through the unexpected point to thereby generate a control signal allowing the pressure of the shock absorber 140 to be returned to the original state thereof and transmit the generated signal to the shock absorber 140.

FIG. 2 is a schematic diagram showing a virtual line positioned on a road surface within a viewing angle range of the distance sensing module 120 according to an embodiment of the present invention.

As shown in FIG. 2, the distance sensing module 120 may sense the distance between the bottom surface of the vehicle and the road surface along the virtual line positioned on the road surface (oblique portion) within a viewing angle of the distance sensing module 120. In this case, the virtual line is included in the road surface within the viewing angle of the distance sensing module 120 and a length or direction thereof is not limited. The virtual line shown in FIG. 2 is a line connecting a left boundary line and a right boundary line of the road surface within the viewing line in a direction parallel with a wheel shaft of the vehicle. As described above, since the distance sensing module 120 according to the embodiment of the present invention measures the distance between the bottom surface of the vehicle and the road surface along the virtual line positioned within the road surface, it may require a lower cost as compared to the case in which the distance between the bottom surface of the vehicle and the road surface is measured over a specific region of the road surface having a plane shape, thereby allowing for data processing at high velocity. Therefore, according to the embodiment of the present invention, the distance sensing module 120 may be a camera having a linear pixel arrangement. In addition, according to the embodiment of the present invention, the distance sensing module 120 may measure the distance between the bottom surface of the vehicle and the road surface along the virtual line to generate a two-dimensional map and may continue to perform the measurement at predetermined intervals in accordance with the vehicle movement to generate a three-dimensional map. When the distance sensing module 120 includes the first camera 121 and the second camera 122, the first camera 121 and the second camera 122 may each generate the two-dimensional map or the three-dimensional map.

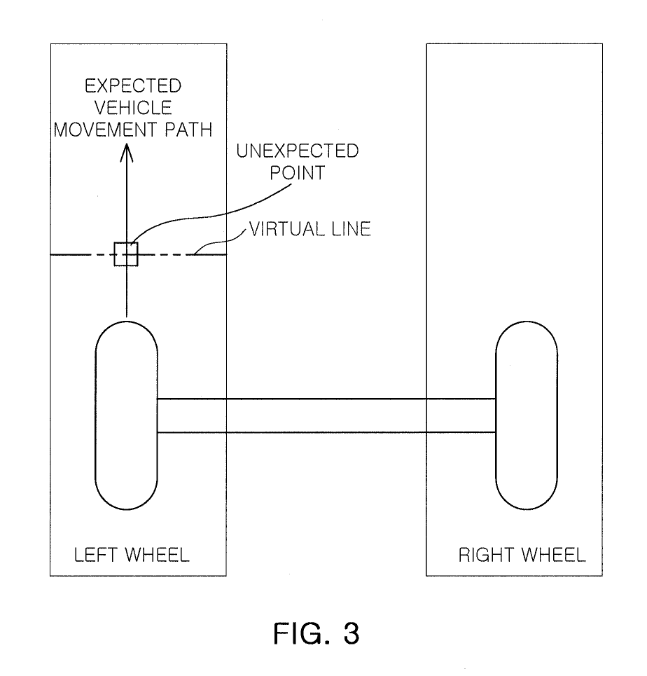

FIG. 3 is a schematic diagram showing a point at which a virtual line positioned on a road surface within a viewing angle range of a distance sensing module according to an embodiment of the present invention intersects with an expected movement path.

The distance sensing module 120 is to cope with the unexpected situations in advance by measuring the distance between the bottom surface of the vehicle and the road surface along the virtual line at a point through which the vehicle directly passes. The electronic control unit 130 extracts the distance between the bottom surface of the vehicle and the road surface at the point at which the virtual line positioned on the road surface within the viewing angle range of the distance sensing module 120 intersects with the expected vehicle movement path, based on the calculated expected vehicle movement path.

As described above, according to the embodiment of the present invention, the electronic control unit 130 extracts the distance between the bottom surface of the vehicle and the road surface at a necessary point, based on the expected vehicle movement path. Thus, even in the case of the rotational movement of the vehicle as well as the straight movement thereof, the shock absorber may be controlled as long as the expected vehicle movement path is not beyond the virtual line. Referring to FIG. 3, it can be seen that the obstacles or the depression is positioned at the point at which the expected vehicle movement path intersects with the virtual line. In this case, when the distance between the bottom surface of the vehicle and the road surface is higher than the preset maximum value or is lower than the preset minimum value due to the obstacles or the depression, the point may be the unexpected point.

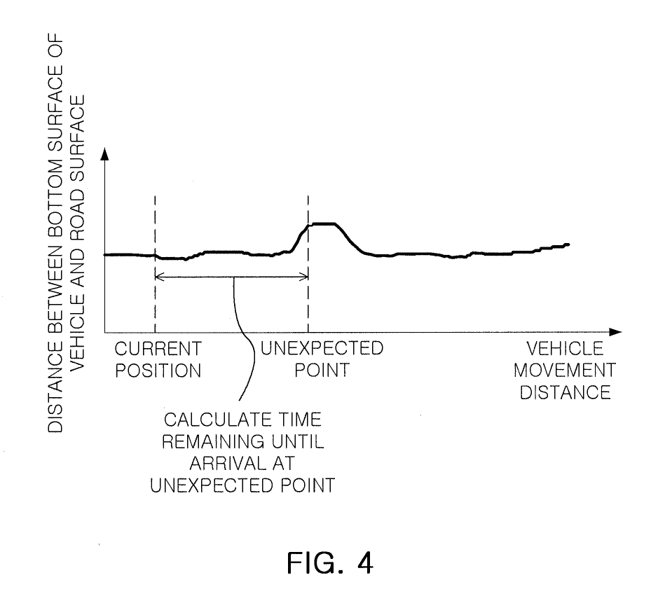

FIG. 4 is a graph showing a distance change between a bottom surface of a vehicle and a road surface at the point at which a virtual line positioned on a road surface within a viewing angle range of a distance sensing module according to an embodiment of the present invention intersects with an expected movement path, depending on a change in a vehicle movement distance according to an embodiment of the present invention.

Referring to FIG. 4, it can be appreciated that there is a point in the vehicle movement direction, at which the distance between the bottom surface of the vehicle and the road surface is increased. In this case, when the distance is higher than the preset maximum value, the point may be the unexpected point. When the electronic control unit 130 determines the point as the unexpected point, the electronic control unit 130 calculates the time consumed for the vehicle to arrive at the unexpected point, based on the velocity of the vehicle. The electronic control unit 130 generates the control signal and transmits the generated control signal to the shock absorber 140 within the time remaining until arrival at the unexpected point to allow the pressure of the shock absorber 140 to be changed, thereby coping with the unexpected situations in advance before the vehicle passes through the unexpected point.

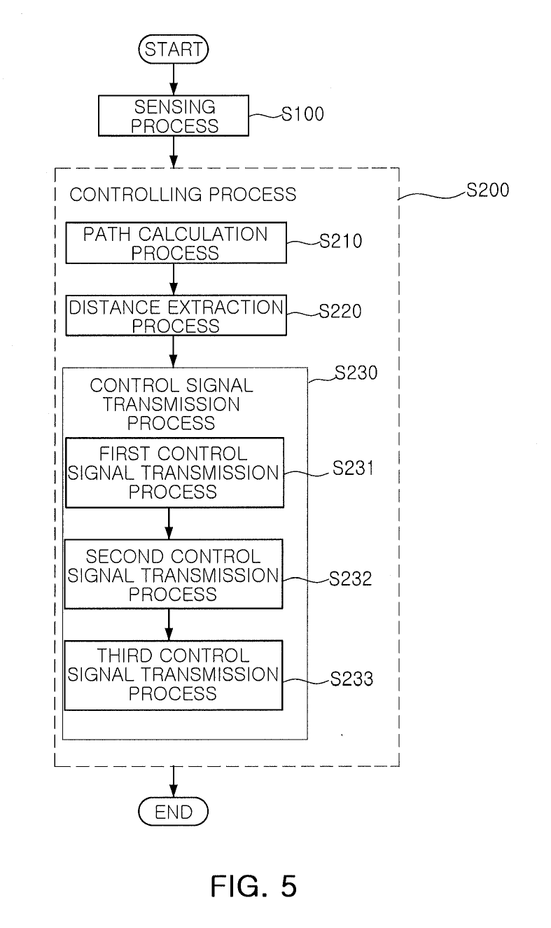

FIG. 5 is a flowchart of a shock absorber control method according to an embodiment of the present invention.

As shown in FIG. 5, a shock absorber control method according to an embodiment of the present invention may include a sensing process (S100) of sensing the vehicle movement information and the distance between the bottom surface of the vehicle and the road surface and a controlling process (S200) of controlling the shock absorber by generating the control signal from the vehicle movement information and the distance to transmit the generated signal to the shock absorber.

In the sensing process (S100) according to the embodiment of the present invention, the vehicle movement information may be sensed by the vehicle movement information sensing module and the distance between the bottom surface of the vehicle and the road surface maybe sensed by the distance sensing module. In this case, in the sensing process (S100), the distance between the bottom surface of the vehicle and the road surface may be sensed along the virtual line positioned on the road surface within the viewing angle range of the distance sensing module. The meaning of the virtual line is the same as being described with reference to FIG. 2.

The controlling process (S200) according to the embodiment of the present invention may include a path calculation process (S210), a distance extraction process (S220), and a control signal transmission process (S230).

In the path calculation process (S210) according to the embodiment of the present invention, the expected vehicle movement path may be calculated from the vehicle movement information.

In the distance extraction process (S220) according to the embodiment of the present invention, in which necessary distance information is extracted from the expected vehicle movement path, only information regarding the distance between the bottom surface of the vehicle and the road surface at the point at which the virtual line positioned on the road surface within the viewing angle range of the distance sensing module 120 intersects with the expected vehicle movement path may be extracted.

The control signal transmission process (S230) according to the embodiment of the present invention may include a first control signal transmission process (S231), a second control signal transmission process (S232), and a third control signal transmission process (S233).

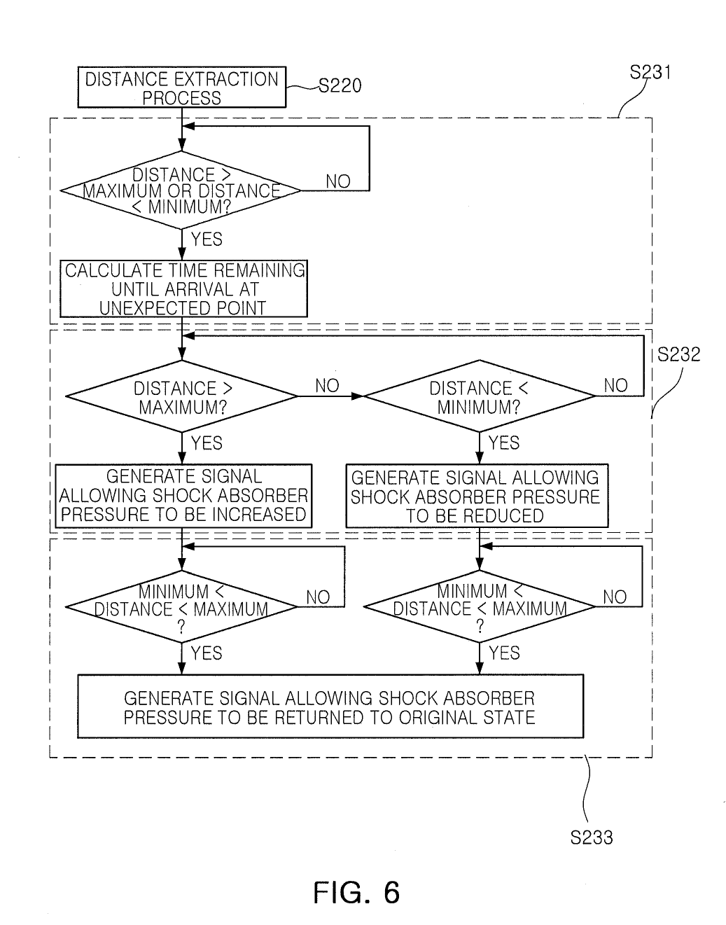

FIG. 6 is a flow chart of a first control signal transmission process (S231), a second control signal transmission process (S232), and a third control signal transmission process (S233) according to an embodiment of the present invention.

First, in the first control signal transmission process (S231) according to the embodiment of the present invention, the unexpected point is determined from the distance information extracted from the distance extraction process (S220) and the time consumed to arrive at the unexpected point is calculated. That is, when the distance between the bottom surface of the vehicle and the road surface at the point at which the virtual line intersects with the expected vehicle movement path is higher than the preset maximum value or lower than the preset minimum value, the point is determined as the unexpected point and the time remaining until arrival at the unexpected point is calculated so as to transmit the control signal to the shock absorber within the time remaining until arrival at the unexpected point.

Next, the second control signal transmission process (S232) according to the embodiment of the present invention may be performed after the first control signal transmission process (S231). In the second control signal transmission process (S232), when the distance between the bottom surface of the vehicle and the road surface is lower than the preset minimum value, the control signal allowing the pressure of the shock absorber 140 to be reduced may be generated and the generated signal may be transmitted to the shock absorber. When the distance between the bottom surface of the vehicle and the road surface is higher than the preset maximum value, the control signal allowing the pressure of the shock absorber 140 to be increased may be generated and the generated signal may be transmitted to the shock absorber. In this manner, the height of the vehicle body from the road surface may be uniformly maintained by controlling the pressure of the shock absorber to thereby improve vehicle ride comfort.

Next, the third control signal transmission process (S233) according to the embodiment of the present invention may be performed after the second control signal transmission process (S232). In the third control signal transmission process (S233), it is redetermined whether the distance between the bottom surface of the vehicle and the road surface is within the ranges of preset maximum and minimum values, within the preset time from the time when the control signal is transmitted to the shock absorber. When the distance is within the ranges of the preset maximum value and preset minimum value, it is considered that the vehicle has passed through the unexpected point and thus, the control signal allowing the pressure of the shock absorber to be returned to the original state may be generated and transmitted to the shock absorber. That is, the pressure of the shock absorber having changed before passing through the unexpected point is returned to the original state thereof after passing through the unexpected point, without the operation of the driver, thereby continuously improving vehicle ride comfort and vehicle movement stability.

As set forth above, according to the embodiments of the present invention, the shock absorber can be controlled in advance to improve vehicle ride comfort and vehicle movement stability.

While the present invention has been shown and described in connection with the embodiments, it will be apparent to those skilled in the art that modifications and variations can be made without departing from the spirit and scope of the invention as defined by the appended claims.

What is claimed is:

1. A shock absorber control apparatus, comprising:
a vehicle movement information sensing module sensing vehicle movement information;
a distance sensing module sensing a distance between a bottom surface of a vehicle and a road surface; and
an electronic control unit receiving the vehicle movement information and the distance to generate a signal for controlling the shock absorber and transmit the signal to the shock absorber.

2. The shock absorber control apparatus of claim 1, wherein the vehicle movement information sensing module includes a velocity sensor sensing a velocity of the vehicle, a steering angle sensor sensing a steering angle of the vehicle, and a gear sensor sensing a gear state of the vehicle.

3. The shock absorber control apparatus of claim 1, wherein the distance sensing module includes at least two cameras.

4. The shock absorber control apparatus of claim 1, wherein the distance sensing module includes a camera having a linear pixel arrangement.

5. The shock absorber control apparatus of claim 1, wherein the distance sensing module senses the distance between the bottom surface of the vehicle and the road surface along a virtual line positioned on the road surface within a viewing angle range of the distance sensing module.

6. The shock absorber control apparatus of claim 1, wherein the electronic control unit receives the vehicle movement information to thereby calculate an expected vehicle movement path.

7. The shock absorber control apparatus of claim 6, wherein the distance sensing module senses the distance between the bottom surface of the vehicle and the road surface along a virtual line positioned on the road surface within a viewing angle range of the distance sensing module, and the electronic control unit extracts the distance between the bottom surface of the vehicle and the road surface at a point at which the virtual line positioned on the road surface within the viewing angle range of the distance sensing module intersects with the expected vehicle movement path.

8. The shock absorber control apparatus of claim 7, wherein the electronic control unit determines the point as an unexpected point when the distance between the bottom surface of the vehicle and the road surface at the point is higher than a preset maximum value or lower than a preset minimum value, calculates time remaining until arrival at the unexpected point, and transmits the signal to the shock absorber within the time remaining until arrival at the unexpected point.

9. The shock absorber control apparatus of claim 1, wherein the electronic control unit generates a signal allowing a pressure of the shock absorber to be reduced when the distance between the bottom surface of the vehicle and the road surface is lower than a preset minimum value and transmits the generated signal to the shock absorber, and the electronic control unit generates a signal allowing the pressure of the shock absorber to be increased when the distance between the bottom surface of the vehicle and the road surface is higher than a preset maximum value and transmits the generated signal to the shock absorber.

10. The shock absorber control apparatus of claim 1, wherein when the electronic control unit generates a signal allowing a pressure of the shock absorber to be increased or a signal allowing the pressure of the shock absorber to be reduced and transmits the generated signal to the shock absorber, the electronic control unit redetermines whether the distance between the bottom surface of the vehicle and the road surface is within ranges of preset maximum and minimum values, within a preset time from time when the signal is transmitted to the shock absorber, and if the distance is within the ranges of preset maximum and minimum values, generates a signal allowing the pressure of the shock absorber to be returned to an original state and transmits the generated signal to the shock absorber.

11. A shock absorber control method, comprising:
a sensing process of sensing vehicle movement information by a vehicle movement information sensing module and sensing a distance between a bottom surface of a vehicle and a road surface by a distance sensing module; and
a controlling process of controlling a shock absorber by generating a signal for controlling the shock absorber from the vehicle movement information and the distance to transmit the generated signal to the shock absorber.

12. The shock absorber control method of claim 11, wherein the controlling process includes a path calculation process, a distance extraction process, and a control signal transmission process.

13. The shock absorber control method of claim 11, wherein in the sensing process, the distance between the bottom surface of the vehicle and the road surface is sensed along a virtual line positioned on the road surface within a viewing angle range of the distance sensing module.

14. The shock absorber control method of claim 12, wherein in the path calculation process, an expected vehicle movement path is calculated from the vehicle movement information.

15. The shock absorber control method of claim 14, wherein in the sensing process, the distance between the bottom surface of the vehicle and the road surface is sensed along a virtual line positioned on the road surface within a viewing angle range of the distance sensing module, and in the distance extraction process, the distance between the bottom surface of the vehicle and the road surface at a point at which the virtual line positioned on the road surface within the viewing angle range of the distance sensing module intersects with the expected vehicle movement path is extracted.

16. The shock absorber control method of claim 15, wherein the control signal transmission process includes a first control signal transmission process, and the first control signal transmission process may include determining the point as an unexpected point when the distance between the bottom surface of the vehicle and the road surface at the point is higher than a preset maximum value or lower than a preset minimum value, calculating time remaining until arrival at the unexpected point, and transmitting the signal to the shock absorber within the time remaining until arrival at the unexpected point.

17. The shock absorber control method of claim 16, wherein the control signal transmission process includes a second control signal transmission process after the first control signal transmission process, and the second control signal transmission process includes generating a signal allowing a pressure of the shock absorber to be reduced when the distance between the bottom surface of the vehicle and the road surface is lower than the preset minimum value to thereby transmit the generated signal to the shock absorber and generating a signal allowing the pressure of the shock absorber to be increased when the distance between the bottom surface of the vehicle and the road surface is higher than the preset maximum value to thereby transmit the generated signal to the shock absorber.

18. The shock absorber control method of claim 17, wherein the control signal transmission process includes a third control signal transmission process after the second control signal transmission process, and the third control signal transmission process includes redetermineing whether the distance between the bottom surface of the vehicle and the road surface is within ranges of preset maximum and minimum values, within a preset time from time when the signal is transmitted to the shock absorber, and if the distance is within the ranges of preset maximum and minimum values, generating a signal allowing the pressure of the shock absorber to be returned to an original state to thereby transmit the generated signal to the shock absorber.
